(19) United States
(12) Patent Application Publication
(10) Pub. No.: US 2026/0353188 A1
(43) Pub. Date: Nov. 5, 2026

(54) COMMUNICATION METHOD, COMMUNICATION APPARATUS, AND STORAGE MEDIUM

(71) Applicant: HUAWEI TECHNOLOGIES CO., LTD., Shenzhen (CN)

(72) Inventors: Shuxin Ye, Shenzhen (CN); Yedan Wu, Shanghai (CN); Yexing Li, Shanghai (CN); Yijun Yu, Shanghai (CN)

(21) Appl. No.: 19/717,840

(22) Filed: Jun. 24, 2026

Related U.S. Application Data
(63) Continuation of application No. PCT/CN2024/127388, filed on Oct. 25, 2024.

(30) Foreign Application Priority Data
Dec. 29, 2023 (CN) 202311865411.2

(51) Int. Cl. H04W 28/08; H04B 7/185; H04W 36/22; H04W 64/00

(52) U.S. Cl. CPC H04W 28/0958; H04B 7/18519; H04B 7/18541; H04W 36/22; H04W 64/006

(57) ABSTRACT

This application relates to the communication field, and provides a communication method, a communication apparatus, and a storage medium, to effectively control load balancing between NTN cells. The method includes: obtaining a configuration parameter, and sending first information, where the configuration parameter includes at least one of a time parameter, a location parameter, and ephemeris information, and the first information indicates to perform load balancing based on the configuration parameter.

### CROSS-REFERENCE TO RELATED APPLICATIONS

This application is a continuation of International Application No. PCT/CN 2024/127388, filed on Oct. 25, 2024, which claims priority to Chinese Patent Application No. 202311865411.2, filed on Dec. 29, 2023, the disclosures of which are hereby incorporated by reference in their entireties.

### TECHNICAL FIELD

This application relates to the communication field, including a communication method, a communication apparatus, and a storage medium.

### BACKGROUND

In terrestrial networks (TN), because reference signal received power (RSRP) of a terminal located in a central area of a cell is greatly different from RSRP of a terminal located in an edge area of the cell, the terminal located in the central area of the cell and the terminal located in the edge area of the cell can be effectively distinguished based on the RSRP. A handover threshold is set, so that the terminal in the edge area of the cell is handed over from the currently camped cell to another cell with more idle resources. In this way, load balancing between cells can be effectively controlled.

However, the foregoing solution is applicable only to the TN scenarios. In non-terrestrial network (NTN) scenarios, a difference between RSRP of terminals located in different location areas of a cell is small. In this case, it is difficult to distinguish, based on the RSRP, a terminal located in an edge area of the cell, and load balancing between cells cannot be effectively controlled.

### SUMMARY

One or more embodiments of this application provide a communication method, a communication apparatus, and a storage medium, to help control load balancing between NTN cells.

According to a first aspect, a communication method is provided. The method may be performed by a first network device, may be performed by a component of a first network device, for example, a processor, a chip, or a chip system of the first network device, or may be implemented by a logical module or software that can implement all or some functions of the first network device. The following uses an example in which the method is performed by the first network device for description. The communication method includes: obtaining at least one of a time parameter, a location parameter, and ephemeris information, and sending first information that indicates to perform load balancing based on a configuration parameter.

It may be understood that the load balancing described in this application may mean that load or quantities of terminals in NTN cells is/are balanced by indicating a terminal to perform handover.

In one or more embodiments of this application, the load balancing may be performed based on the at least one of the time parameter, the location parameter, and the ephemeris information. Compared with a signal strength parameter, at least one of the time parameter, the location parameter, or the ephemeris information can be better used to control a quantity of terminals to be handed over, and therefore can be better adapted to an NTN scenario, and load balancing between NTN cells can be effectively controlled.

With reference to the first aspect, in one or more embodiments, the time parameter indicates time for performing the load balancing, for example, a time period/time range, a start time and a duration for performing the load balancing, or a start time and an end time for performing the load balancing. The location parameter indicates an area in which the load balancing is performed, for example, a regular area/an irregular area, or longitude and latitude information and a preset distance of at least one reference point in which the load balancing is performed, or longitude and latitude information of a plurality of reference points in which the load balancing is performed. In this way, the time parameter and the location parameter can be determined, so that the first network device can determine the first information more clearly.

With reference to the first aspect, in one or more embodiments, the obtaining the configuration parameter includes: receiving a configuration parameter from a third network device. For example, the configuration parameter may be obtained from a side of another network device (that is, the third network device) other than the first network device, to reduce complexity of obtaining the configuration parameter and simplify a system design.

With reference to the first aspect, in one or more embodiments, the method provided in one or more embodiments of this application further includes: sending second information to the third network device, and receiving third information from the third network device, where the second information indicates the configuration parameter obtained by the first network device, to request to verify the configuration parameter, and the third information indicates feasibility of the configuration parameter.

For example, the first network device and the third network device may jointly verify the configuration parameter indicated by the second information, to determine the feasibility of the configuration parameter indicated by the second information. In this way, the first network device may subsequently control, based on the feasibility of the configuration parameter indicated by the second information, whether to perform the load balancing based on the configuration parameter, to help ensure that the load balancing can be normally performed on the basis of successful verification.

With reference to the first aspect, in one or more embodiments, the sending the first information includes: when the feasibility of the configuration parameter indicated by the second information meets a preset requirement, sending the first information to a second network device. In this way, it can be ensured as much as possible that the load balancing can be normally performed.

With reference to the first aspect, in one or more embodiments, when the configuration parameter includes the time parameter and/or the location parameter, the obtaining the configuration parameter includes: receiving the ephemeris information, and determining the configuration parameter based on the ephemeris information. In this way, the first network device may determine the configuration parameter by itself, so that the first network device can subsequently generate the first information based on the configuration parameter.

With reference to the first aspect, in one or more embodiments, the configuration parameter further includes a signal strength parameter, and the signal strength parameter indicates a signal strength range for performing the load balancing. In this way, the first network device may combine the at least one of the time parameter, the location parameter, and the ephemeris information with the signal strength parameter, to generate the first information. This expands diversity of parameters required for performing the load balancing, so as to better improve a load balancing effect.

With reference to the first aspect, in one or more embodiments, the first information further indicates to perform the load balancing based on a target parameter, and the target parameter is determined from the configuration parameter based on a network type. In this way, the first network device may perform indication for load balancing for different types of networks, so as to better improve a load balancing effect.

With reference to the first aspect, in one or more embodiments, the network type includes a TN type and an NTN type, so that the communication method recorded in this application can be applied to a TN scenario and/or an NTN scenario, thereby enriching application scenarios of the solutions provided in this application.

According to a second aspect, a communication method is provided. The method may be performed by a second network device, may be performed by a component of a second network device, for example, a processor, a chip, or a chip system of the second network device, or may be implemented by a logical module or software that can implement all or some functions of the second network device. The following uses an example in which the method is performed by the second network device for description. The communication method includes: receiving first information, where the first information indicates to perform load balancing based on a configuration parameter, and the configuration parameter includes at least one of a time parameter, a location parameter, and ephemeris information.

With reference to the second aspect, in one or more embodiments, the time parameter indicates time for performing the load balancing, and the location parameter indicates an area at which the load balancing is performed.

With reference to the second aspect, in one or more embodiments, the configuration parameter further includes a signal strength parameter, and the signal strength parameter indicates a signal strength range for performing the load balancing.

With reference to the second aspect, in one or more embodiments, the first information further indicates to perform the load balancing based on a target parameter, and the target parameter is determined from the configuration parameter based on a network type.

With reference to the second aspect, in one or more embodiments, the network type includes a TN type and an NTN type.

For technical effects brought by any one of the second aspect or one or more embodiments of the second aspect, refer to technical effects brought by a corresponding implementation of the first aspect. Details are not described herein again.

According to a third aspect, a communication apparatus is provided, to implement the foregoing methods. The communication apparatus may be the first network device in any one of the first aspect or one or more embodiments of the first aspect, or an apparatus including the first network device, or an apparatus included in the first network device, for example, a chip. In one or more embodiments, the communication apparatus may be the second network device in any one of the second aspect or one or more embodiments of the second aspect, or an apparatus including the second network device, or an apparatus included in the second network device, for example, a chip. The communication apparatus includes a corresponding module, unit, or means for implementing the foregoing method. The module, unit, or means may be implemented by hardware or software, or implemented by hardware executing corresponding software. The hardware or the software includes one or more modules or units corresponding to the foregoing functions.

In one or more embodiments, the communication apparatus may include a processing module and a transceiver module. The transceiver module may also be referred to as a transceiver unit, and is configured to implement a sending function and/or a receiving function in any one of the foregoing aspects and the embodiments of the foregoing aspects. The transceiver module may include a transceiver circuit, a transceiver machine, a transceiver, or a communication interface. The processing module may be configured to implement a processing function in any one of the foregoing aspects and the embodiments of the foregoing aspects.

In one or more embodiments, the transceiver module includes a sending module and a receiving module, respectively configured to implement the sending function and the receiving function in any one of the foregoing aspects and the embodiments of the foregoing aspects.

According to a fourth aspect, a communication apparatus is provided, and includes a processor and a memory. The memory is configured to store computer instructions. When the processor executes the instructions, the communication apparatus is caused to perform the method in any one of the foregoing aspects. The communication apparatus may be the first network device in any one of the first aspect or one or more embodiments of the first aspect, or an apparatus including the first network device, or an apparatus included in the first network device, for example, a chip. In one or more embodiments, the communication apparatus may be the second network device in any one of the second aspect or one or more embodiments of the second aspect, or an apparatus including the second network device, or an apparatus included in the second network device, for example, a chip.

According to a fifth aspect, a communication apparatus is provided, and includes a processor and a communication interface. The communication interface is configured to communicate with a module other than the communication apparatus. The processor is configured to execute a computer program or instructions, to cause the communication apparatus to perform the method in any one of the foregoing aspects. The communication apparatus may be the first network device in any one of the first aspect or one or more embodiments of the first aspect, or an apparatus including the first network device, or an apparatus included in the first network device, for example, a chip. In one or more embodiments, the communication apparatus may be the second network device in any one of the second aspect or one or more embodiments of the second aspect, or an apparatus including the second network device, or an apparatus included in the second network device, for example, a chip.

According to a sixth aspect, a communication apparatus is provided, and includes at least one processor. The processor is configured to execute a computer program or instructions stored in a memory, to cause the communication apparatus to perform the method in any one of the foregoing aspects. The memory may be coupled to the processor, or may be independent of the processor. The communication apparatus may be the first network device in any one of the first aspect or one or more embodiments of the first aspect, or an apparatus including the first network device, or an apparatus included in the first network device, for example, a chip. In one or more embodiments, the communication apparatus may be the second network device in any one of the second aspect or one or more embodiments of the second aspect, or an apparatus including the second network device, or an apparatus included in the second network device, for example, a chip.

According to a seventh aspect, a non-transitory computer-readable storage medium is provided. The computer-readable storage medium stores a computer program or instructions. When the computer program or the instructions are run on a communication apparatus, the communication apparatus is caused to perform the method in any one of the foregoing aspects or one or more embodiments of the foregoing aspects.

According to an eighth aspect, a tangible computer program product including instructions is provided. When the computer program product runs on a communication apparatus, the communication apparatus is caused to perform the method in any one of the foregoing aspects or one or more embodiments of the foregoing aspects.

According to a ninth aspect, a communication apparatus is provided (for example, the communication apparatus may be a chip or a chip system). The communication apparatus includes a processor, configured to implement a function in any one of the foregoing aspects or one or more embodiments of the foregoing aspects.

In one or more embodiments, the communication apparatus includes a memory, and the memory is configured to store program instructions and data.

In one or more embodiments, when the apparatus is a chip system, the apparatus may include a chip, or may include a chip and another discrete device.

It may be understood that when the communication apparatus in any one of the third aspect to the sixth aspect is a chip, the foregoing sending action/function may be understood as output, and the foregoing receiving action/function may be understood as input.

According to a tenth aspect, a communication method is provided. The communication method includes the method according to any one of the first aspect or one or more embodiments of the first aspect and the method according to any one of the second aspect or one or more embodiments of the second aspect.

According to an eleventh aspect, a communication system is provided. The communication system includes the first network device in the foregoing aspects and the second network device in the foregoing aspects.

For technical effects brought by any implementation of the third aspect to the eleventh aspect, refer to technical effects brought by a corresponding implementation of the first aspect. Details are not described herein again.

It should be noted that various embodiments of any one of the foregoing aspects may be combined provided that the solutions are not contradictory.

### BRIEF DESCRIPTION OF DRAWINGS

FIG. 1 is a schematic flowchart of load balancing according to one or more embodiments of this application;

FIG. 2 is a diagram of a TN scenario according to one or more embodiments of this application;

FIG. 3 is a diagram of an NTN scenario according to one or more embodiments of this application;

FIG. 4 is a diagram of handover in a load balancing scenario according to one or more embodiments of this application;

FIG. 5 is a diagram of handover in another load balancing scenario according to one or more embodiments of this application;

FIG. 6 is a diagram of a structure of a communication system according to one or more embodiments of this application;

FIG. 7 is a diagram of a structure of a communication apparatus according to one or more embodiments of this application;

FIG. 8 is a schematic flowchart of a communication method according to one or more embodiments of this application;

FIG. 9a, FIG. 9b, and FIG. 9c are diagrams of three representations of time periods according to one or more embodiments of this application;

FIG. 10a and FIG. 10b are diagrams of two representations of regions according to one or more embodiments of this application;

FIG. 11 is a diagram of coverage time and areas of satellites according to one or more embodiments of this application;

FIG. 12 is a schematic flowchart of another communication method according to one or more embodiments of this application;

FIG. 13 is a schematic flowchart of another communication method according to one or more embodiments of this application;

FIG. 14 is a schematic flowchart of another communication method according to one or more embodiments of this application;

FIG. 15 is a schematic flowchart of another communication method according to one or more embodiments of this application; and

FIG. 16 is a diagram of a structure of another communication apparatus according to one or more embodiments of this application.

### DESCRIPTION OF EMBODIMENTS

For ease of understanding technical solutions provided in embodiments of this application, technologies related to this application are first described briefly. The brief descriptions are as follows.

### Mobility Load Balancing (Mobility Load Balance)

The mobility load balancing, which may also be briefly referred to as load balancing, means that terminals in a plurality of cells are balanced and/or service volumes of the terminals in the plurality of cells are balanced, so that a difference between load of the cells or a difference between quantities of terminals in the cells is small.

Randomness of terminal locations and diversity of service requirements easily cause a great change in an amount of cell load. As a result, load of some cells in the plurality of cells is high, even a problem like network congestion occurs, and load of other cells in the plurality of cells is low, resulting in a waste of resources in the other cells. A load balancing technology can effectively balance coverage of a plurality of cells, to avoid network congestion or a resource waste in some cells.

For example, if there are an access network device 1 and an access network device 2, and load of the access network device 1 is higher than load of the access network device 2, the access network device 1 and the access network device 2 may exchange resource usage, and the access network device 1 may modify a handover threshold of a terminal, so that some terminals in a cell covered by the access network device 1 are handed over from the current serving cell to a cell covered by the access network device 2, so as to balance load of the access network device 1 and the access network device 2.

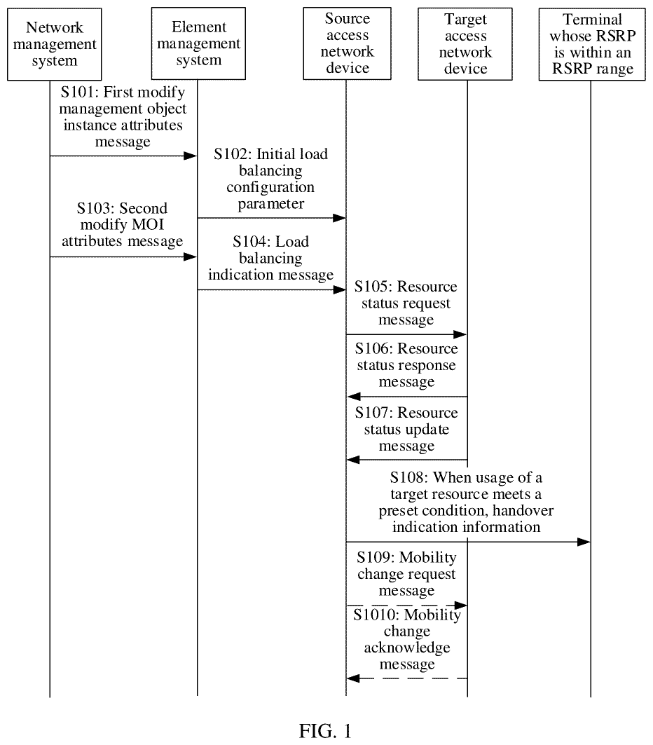

It should be noted that an existing load balancing procedure requires interaction between a plurality of communication devices. Referring to FIG. 1, the following describes the load balancing procedure.

S101: A network management system (NMS) sends a first modify management object instance (MOI) attributes (modify MOI attributes) message to an element management system (EMS), and correspondingly, the EMS receives the first modify MOI attributes message from the NMS.

The first modify MOI attributes message indicates an initial load balancing configuration parameter. The load balancing configuration parameter may include an RSRP parameter. The RSRP parameter may indicate an RSRP range for performing load balancing. The foregoing is merely an example description of the load balancing configuration parameter. The load balancing configuration parameter may further include other information. This is not limited in this embodiment of this application.

S102: The EMS sends the initial load balancing configuration parameter to a source access network device, and correspondingly, the source access network device receives the initial load balancing configuration parameter from the EMS.

The source access network device may be an access network device whose load is greater than or equal to a load threshold.

In one or more embodiments, the EMS may set the load threshold based on an actual network state or experience. For example, the EMS sets the load threshold to 95 bytes per second (bps). This is not limited in this embodiment of this application.

S103: The NMS sends a second modify MOI attributes message to the EMS, and correspondingly, the EMS receives the second modify MOI attributes message from the NMS.

The second modify MOI attributes message indicates to perform load balancing.

S104: The EMS sends a load balancing indication message to the source access network device, and correspondingly, the source access network device receives the load balancing indication message from the EMS.

The load balancing indication message indicates to perform load balancing.

S105: The source access network device sends a resource status request message to a target access network device, and correspondingly, the target access network device receives the resource status request message from the source access network device.

The resource status request message indicates the target access network device to measure a target resource.

In one or more embodiments, after S105, the resource status request message may further indicate the target access network device to measure a resource other than the target resource, or the resource status request message may further indicate the target access network device to stop measuring the target resource.

S106: The target access network device sends a resource status response message to the source access network device, and correspondingly, the source access network device receives the resource status response message from the target access network device.

The resource status response message indicates that the target access network device has started to measure the target resource.

S107: The target access network device sends a resource status update message to the source access network device, and correspondingly, the source access network device receives the resource status update message from the target access network device.

The resource status update message indicates a measurement report, and the measurement report includes resource usage of the target resource. The foregoing is merely an example description of the measurement report. The measurement report may further include other information. This is not limited in this embodiment of this application.

In one or more embodiments, the target access network device may periodically send the resource status update message to the source access network device based on a configured measurement report reporting periodicity, and correspondingly, the source access network device periodically receives the resource status update message from the target access network device.

S108: When the usage of the target resource meets a preset condition, the source access network device sends handover indication information to a terminal whose RSRP is within the RSRP range, and correspondingly, the terminal receives the handover indication information from the source access network device.

The handover indication information indicates the terminal to be handed over to the target access network device.

In one or more embodiments, the initial load balancing configuration parameter set by the NMS generally has a wide application scope, but may have low practicability for some access network devices. Therefore, the source access network device and the target access network device may negotiate to modify the load balancing configuration parameter, so as to better perform load balancing. The following describes an implementation process in which the source access network device and the target access network device negotiate to modify the load balancing configuration parameter.

S109: The source access network device sends a mobility change request message to the target access network device, and correspondingly, the target access network device receives the mobility change request message from the source access network device.

The mobility change request indicates the target access network device to adjust the load balancing configuration parameter, and the mobility change request may carry a modified load balancing configuration parameter. For example, when resource utilization of the target access network device is low, the source access network device may extend the RSRP range indicated by the load balancing configuration parameter.

S110: The target access network device sends a mobility change acknowledge message to the source access network device, and correspondingly, the source access network device receives the mobility change acknowledge message from the target access network device.

When the target access network device accepts the modified load balancing configuration parameter carried in the mobility change request, the mobility change acknowledge message may be a mobility change acknowledge message. The mobility change acknowledge message indicates that the target access network device has modified the load balancing configuration parameter. When the target access network device does not accept the modified load balancing configuration parameter carried in the mobility change request, the mobility change acknowledge message indicates that the target access network device does not modify the load balancing configuration parameter, and the mobility change acknowledge request may carry a modified load balancing configuration parameter accepted by the target access network device.

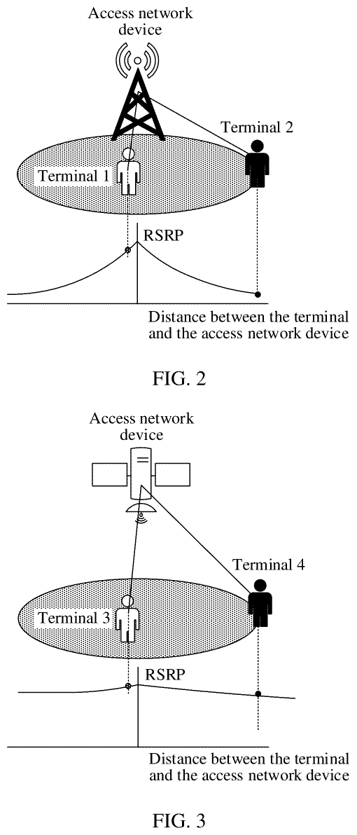

It can be learned from the process in FIG. 1 that the existing load balancing process is performed based on the RSRP range, and the process is applicable to load balancing in a TN network. Referring to FIG. 2, in the TN, an access network device is located on the ground. In this case, a distance between a terminal covered by the access network device and the access network device does not exceed a particular threshold. FIG. 2 shows a curve of a relationship between a distance between a terminal and an access network device and RSRP of the terminal. There is a definite negative correlation between the distance between the terminal and the access network device and the RSRP of the terminal. For example, RSRP of a terminal that is close to the access network device is high, and RSRP of a terminal that is far away from the terrestrial access network device is low. Referring to FIG. 2, because a distance between a terminal 1 and the terrestrial access network device is shorter than that between a terminal 2 and the terrestrial access network device, RSRP of the terminal 1 is higher than RSRP of the terminal 2. In this case, load balancing may be performed based on the procedure described in connection with FIG. 1.

However, in an NTN, as described in connection with FIG. 3, an access network device is located in the air, and is generally far away from terminals. For example, there is a high probability that a distance between a terminal covered by the access network device and the access network device exceeds a particular threshold. FIG. 3 shows a curve of a relationship between a distance between a terminal and an access network device and RSRP of the terminal. There is no definite negative correlation between the distance between the terminal and the access network device and the RSRP of the terminal. Consequently, there is no great difference between RSRP of terminals within coverage of the access network device. Referring to FIG. 3, although a distance between a terminal 3 and the access network device is shorter than that between a terminal 4 and the access network device, a difference between RSRP of the terminal 3 and RSRP of the terminal 4 is small.

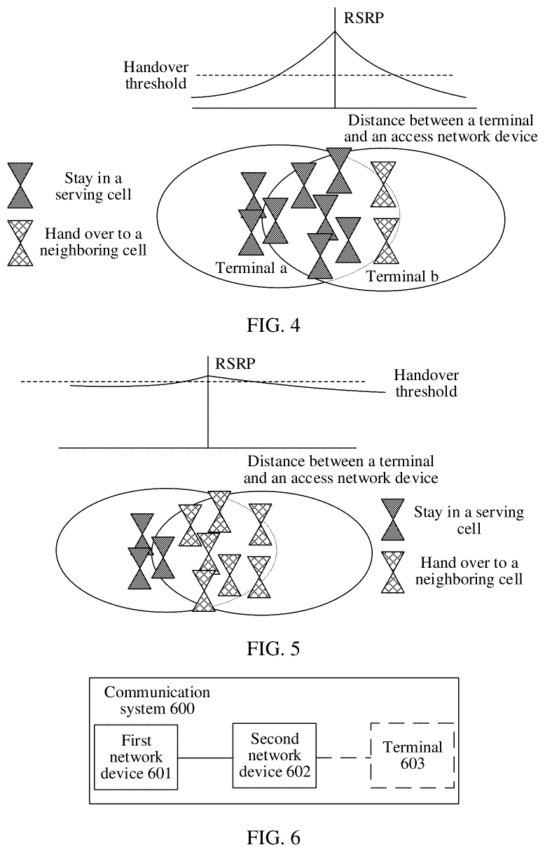

However, in a load balancing scenario, as described in connection with FIG. 4, because RSRP of a terminal located in a central area of a TN cell is greatly different from RSRP of a terminal located in an edge area of the TN cell, the terminal (for example, a terminal a in FIG. 4) located in the central area of the TN cell and the terminal (for example, a terminal b in FIG. 4) located in the edge area of the TN cell can be effectively selected based on the RSRP. A handover threshold is set, so that the terminal b in FIG. 4 is handed over from the currently camped TN cell to another TN cell with more idle resources. In this way, load balancing between TN cells can be effectively controlled.

However, the foregoing solution is applicable only to TN scenarios. In NTN scenarios, a difference between RSRP of terminals located in different location areas of an NTN cell is small. In this case, it is difficult to distinguish, based on the RSRP, a terminal located in an edge area of the NTN cell. As a result, it is likely that an excessively low handover threshold causes a very few terminals to be handed over to a neighboring cell, such that an excessively high load of the serving cell remains unrelieved. In one or more embodiments, as described in connection with FIG. 5, it is likely that an excessively high handover threshold causes too many terminals to be handed over to a neighboring cell, which in turn results in an excessively low load of the serving cell and an excessively high load of a neighboring cell, such that load balancing is still not achieved.

In view of this, this application provides a communication method. A first network device may obtain a configuration parameter, and send first information, to indicate to perform load balancing based on the configuration parameter. The configuration parameter recorded in this application may include at least one of a time parameter, a location parameter, or ephemeris information. Compared with a signal strength parameter, at least one of the time parameter, the location parameter, or the ephemeris information can be better used to control a quantity of terminals to be handed over, and therefore can be better adapted to an NTN scenario, and load balancing between NTN cells can be effectively controlled.

The following describes technical solutions in embodiments of this application with reference to accompanying drawings in embodiments of this application.

For ease of understanding of embodiments of this application, the following descriptions are first provided before embodiments of this application are described.
1. In embodiments of this application, for ease of description, when numbering is involved, numbering may be performed consecutively starting from 1, or may be performed consecutively starting from 0, or may be performed starting from any parameter. It should be understood that the foregoing descriptions are all settings for ease of describing the technical solutions provided in embodiments of this application, but are not intended to limit the scope of embodiments of this application.
2. In embodiments of this application, “indication” may include a direct indication and an indirect indication, or may include an explicit indication and an implicit indication. Information indicated by a piece of information (for example, first indication information described below) is referred to as to-be-indicated information. In one or more embodiments, the to-be-indicated information is indicated in a plurality of manners. By way of example and not limitation, the to-be-indicated information may be directly indicated, for example, the to-be-indicated information or an index of the to-be-indicated information is indicated. In one or more embodiments, the to-be-indicated information may be indirectly indicated by indicating other information, and there is an association relationship between the other information and the to-be-indicated information. In one or more embodiments, only a part of the to-be-indicated information may be indicated, and the other part of the to-be-indicated information is known or pre-agreed on. For example, particular information may be indicated by using an arrangement sequence of all pieces of information that is pre-agreed on (for example, specified in a protocol), to reduce indication overheads to some extent. In addition, a common part of all pieces of information may be identified and indicated in a unified manner, to reduce indication overheads caused by separately indicating same information.

Furthermore, particular indication manners may be various indication manners, for example, but not limited to, the foregoing indication manners and various combinations thereof. It can be learned from the foregoing descriptions that, for example, when a plurality of pieces of information of a same type are to be indicated, different information may be indicated in different manners. In one or more embodiments, a particular indication manner may be selected based on a particular specification. The selected indication manner is not limited in embodiments of this application. In this way, the indication manner in embodiments of this application should be understood as covering various methods that can enable a to-be-indicated party to learn of to-be-indicated information.

It should be understood that the to-be-indicated information may be sent as a whole, or may be divided into a plurality of pieces of sub-information for separate sending. In addition, sending periodicities and/or sending occasions of these pieces of sub-information may be the same or may be different. A specific sending method is not limited in embodiments of this application. The sending periodicities and/or the sending occasions of these pieces of sub-information may be predefined, for example, predefined according to a protocol, or may be configured by a transmit-end device by sending configuration information to a receive-end device.
3. “Predefinition” or “preconfiguration” may be implemented by pre-storing corresponding code or a corresponding table in a device (for example, including a first network device and/or a second network device) or in another manner that can indicate related information. A specific implementation of “predefinition” or “preconfiguration” is not limited in embodiments of this application. “Storage” may be storage in one or more memories. The one or more memories may be separately disposed, or may be integrated into an encoder, a decoder, a processor, or a communication apparatus. In one or more embodiments, a part of the one or more memories may be separately disposed, and a part may be integrated into a decoder, a processor, or a communication apparatus. A type of the memory may be a storage medium in any form. This is not limited in embodiments of this application.
4. A “protocol” in embodiments of this application may be a standard protocol in the communication field, for example, may include a long term evolution (LTE) protocol, a new radio (NR) protocol, and a related protocol applied to a future communication system. This is not limited in embodiments of this application.
5. In embodiments of this application, descriptions such as “when . . . ” , “in a case of . . . ” , and “if” all mean that a device (for example, the first network device and/or the second network device) performs corresponding processing in an objective case, and are not intended to limit time, and the device (for example, the first network device and/or the second network device) is not required to perform a determining action during implementation, and do not mean that there is another limitation.
6. In the descriptions of this application, “/” represents an “or” relationship between associated objects unless otherwise specified. For example, A/B may represent A or B. The term “and/or” in embodiments of this application describes only an association relationship between associated objects and indicates that three relationships may exist. For example, A and/or B may indicate the following three cases: Only A exists, both A and B exist, and only B exists, where A and B may be singular or plural. In addition, in the descriptions of embodiments of this application, unless otherwise specified, “a plurality of” means two or more. “At least one item (piece) of the following” or a similar expression thereof means any combination of these items, including a single item (piece) or any combination of a plurality of items (pieces). For example, at least one item (piece) of a, b, or c may represent a, b, c, a and b, a and c, b and c, or a, b, and c, where a, b, and c may be singular or plural. In addition, to clearly describe the technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference. In addition, in embodiments of this application, terms such as “example” or “for example” are used to represent giving an example, an illustration, or a description. Any embodiment or design scheme described as an “example” or “for example” in embodiments of this application should not be explained as being more preferred or having more advantages than another embodiment or design scheme. Use of the terms such as “example” or “for example” is intended to present a related concept in a particular manner for ease of understanding.

In addition, a communication architecture and a service scenario described in embodiments of this application are intended to describe the technical solutions in embodiments of this application more clearly, and do not constitute a limitation on the technical solutions provided in embodiments of this application. A person of ordinary skill in the art may know that with evolution of the communication architecture and emergence of new service scenarios, the technical solutions provided in embodiments of this application are also applicable to similar technical problems.

FIG. 6 is a diagram of a structure of a communication system according to one or more embodiments of this application. The communication system 600 includes a first network device 601 and a second network device 602. The first network device 601 and the second network device 602 may be connected in a wireless manner. It should be understood that quantities of first network devices 601 and second network devices 602 in FIG. 6 are merely examples, and there may be more or fewer first network devices 601 and second network devices 602.

In one or more embodiments, the first network device 601 obtains a configuration parameter, and sends first information, where the configuration parameter includes at least one of a time parameter, a location parameter, and ephemeris information; and the first information indicates to perform load balancing based on the configuration parameter. For additional details, refer to subsequent method embodiments. Details are not described herein.

In one or more embodiments, the second network device 602 receives first information. The first information indicates to perform load balancing based on a configuration parameter, and the configuration parameter includes at least one of a time parameter, a location parameter, and ephemeris information. For additional details, refer to subsequent method embodiments. Details are not described herein.

In some possible implementations, the first network device 601 may be an NMS or an EMS. When the first network device is an NMS, the second network device 602 may be an EMS. When the first network device is an EMS, the second network device 602 may be an access network device. In one or more embodiments, the access network device may be an access network device in an NTN.

In one or more embodiments, the NMS in embodiments of this application may monitor a status of a network, or further generate or modify a network configuration command, for example, monitor a load status of a network device, or generate a configuration parameter or a command related to load balancing.

In one or more embodiments, the EMS in embodiments of this application may also monitor a status of a network, or further generate or modify a network configuration command. In addition, the EMS can also construct a digital twin entity.

In one or more embodiments, the access network device in embodiments of this application may include an evolved NodeB (NodeB or eNB or e-NodeB) in a long term evolution (LTE) system or an LTE-advanced (LTE-A) system, for example, a general macro base station eNB and a micro base station eNB in a heterogeneous network scenario. In one or more embodiments, the access network device may include a next generation NodeB (gNB) in a new radio (NR) system. In one or more embodiments, the access network device may include a transmission reception point (TRP), a home base station (for example, home evolved NodeB or home NodeB, HNB), a baseband unit (BBU), a baseband unit pool (BBU pool), a wireless fidelity (Wi-Fi) access point (AP), or the like. In one or more embodiments, the access network device may include a base station in a non-terrestrial network (NTN), that is, may be deployed on an airplane platform or a satellite. In the NTN, a network device or an access device may be used as a layer 1 (L1) relay, may be used as a base station, or may be used as an integrated access and backhaul (IAB) node. In one or more embodiments, the first network device may be a device that is in an IoT and that implements functions of a base station, for example, a device that is in uncrewed aerial vehicle communication, V2X, D2D, or machine-to-machine (M2M) and that implements the functions of the base station.

In one or more embodiments, the communication system 600 may further include a terminal 603.

In one or more embodiments, a terminal device in embodiments of this application may be a device configured to implement a wireless communication function, for example, a terminal or a chip that may be used in a terminal. The terminal may be user equipment (UE), an access terminal, a terminal unit, a terminal station, a mobile station, a remote station, a remote terminal, a mobile device, a wireless communication device, a terminal agent, a terminal apparatus, or the like in a 5G network or a future evolved public land mobile network (PLMN). The access terminal may be a cellular phone, a cordless phone, a session initiation protocol (SIP) phone, a wireless local loop (WLL) station, a personal digital assistant (PDA), a handheld device with a wireless communication function, a compute device or another processing device connected to a wireless modem, a vehicle-mounted device or a wearable device, a virtual reality (VR) terminal device, an augmented reality (AR) terminal device, a wireless terminal in industrial control, a wireless terminal in self-driving, a wireless terminal in remote medical, a wireless terminal in a smart grid, a wireless terminal in transportation safety, a wireless terminal in a smart city, a wireless terminal in a smart home, or the like. In one or more embodiments, the terminal device may be mobile or fixed.

In one or more embodiments, the first network device and the second network device in embodiments of this application may also be referred to as communication apparatuses, and each may be a general-purpose device or a dedicated device. This is not specifically limited in embodiments of this application.

In one or more embodiments, a related function of the first network device or the second network device in embodiments of this application may be implemented by one device, may be jointly implemented by a plurality of devices, or may be implemented by one or more functional modules in one device. This is not specifically limited in embodiments of this application. It may be understood that the foregoing function may be a network element in a hardware device, may be a software function running on dedicated hardware, a combination of hardware and software, or a virtualization function instantiated on a platform (for example, a cloud platform).

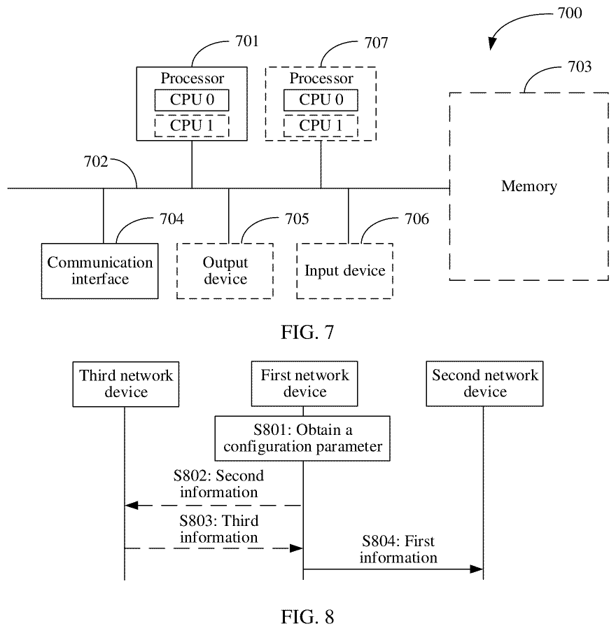

For example, the related function of the first network device or the second network device in embodiments of this application may be implemented through a communication apparatus 700 in FIG. 7. FIG. 7 is a diagram of a structure of the communication apparatus 700 according to one or more embodiments of this application. The communication apparatus 700 includes one or more processors 701, a communication line 702, and at least one communication interface (only an example in which a communication interface 704 and one processor 701 are included is used for description in FIG. 7), and may further include a memory 703.

The processor 701 may be a general-purpose central processing unit (CPU), a microprocessor, an application-specific integrated circuit (ASIC), or one or more integrated circuits configured to control program execution in the solutions of this application.

The communication line 702 may include a path, configured to connect different components.

The communication interface 704 may be a transceiver module configured to communicate with another device or a communication network, for example, an Ethernet, a RAN, or a wireless local area network (WLAN). For example, the transceiver module may be an apparatus like a transceiver or a transceiver machine. In one or more embodiments, the communication interface 704 may be a transceiver circuit located in the processor 701, and is configured to implement signal input and signal output of the processor.

The memory 703 may be an apparatus having a storage function. For example, the memory 703 may be a read-only memory (ROM) or another type of static storage device that can store static information and instructions, a random access memory (RAM) or another type of dynamic storage device that can store information and instructions, or may be an electrically erasable programmable read-only memory (EEPROM), a compact disc read-only memory (CD-ROM) or another compact disc storage, optical disc storage (including a compact disc, a laser disc, an optical disc, a digital versatile disc, a Blu-ray disc, and the like), a magnetic disk storage medium or another magnetic storage device, or any other medium that can be used to carry or store expected program code in a form of instructions or a data structure and that can be accessed by a computer, but is not limited thereto. The memory may independently exist and is connected to the processor through the communication line 702. The memory may be integrated with the processor.

The memory 703 is configured to store computer-executable instructions for performing the solutions in this application, and the processor 701 controls execution. The processor 701 is configured to execute the computer-executable instructions stored in the memory 703, to implement the communication method provided in embodiments of this application.

In one or more embodiments, in embodiments of this application, the processor 701 may perform a processing-related function in the communication method provided in the following embodiments of this application, and the communication interface 704 is responsible for communicating with the another device or the communication network. This is not specifically limited in embodiments of this application.

In one or more embodiments, the memory 703 in embodiments of this application may be further configured to store information or a parameter described in the following embodiments, for example, first indication information.

The computer-executable instructions in embodiments of this application may also be referred to as application code. This is not specifically limited in embodiments of this application.

In one or more embodiments, the processor 701 may include one or more CPUs, for example, a CPU 0 and a CPU 1 in FIG. 7.

In one or more embodiments, the communication apparatus 700 may include a plurality of processors, for example, the processor 701 and a processor 707 described in connection with FIG. 7. Each of the processors may be a single-core (single-CPU) processor, or may be a multi-core (multi-CPU) processor. The processor herein may be one or more devices, circuits, and/or processing cores configured to process data (for example, computer program instructions).

In one or more embodiments, the communication apparatus 700 may further include an output device 705 and an input device 706. The output device 705 communicates with the processor 701, and may display information in a plurality of manners.

The communication apparatus 700 may be a general-purpose apparatus or a dedicated apparatus. For example, the communication apparatus 700 may be a desktop computer, a portable computer, a network server, a personal digital assistant (PDA), a mobile phone, a tablet computer, a wireless terminal device, an embedded device, or a device having a structure similar to that in FIG. 7. A type of the communication apparatus 700 is not limited in embodiments of this application.

The following describes the communication method provided in embodiments of this application in detail with reference to FIG. 8.

It should be noted that in the following embodiments of this application, a name of a message between network elements, a name of each parameter, a name of each piece of information, or the like is merely an example, and may be another name in another embodiment. This is not specifically limited in the method provided in embodiments of this application.

It may be understood that in embodiments of this application, each network element may perform some or all of the steps in embodiments of this application. These steps or operations are merely examples. In embodiments of this application, other operations or variations of various operations may be further performed. In addition, the steps may be performed in a sequence different from that presented in embodiments of this application, and not all the operations in embodiments of this application may be performed.

FIG. 8 is an example of a communication method according to one or more embodiments of this application. The method is described by using interaction between a first network device and a second network device as an example. An action of the first network device in the method may be performed by an apparatus/a module in the first network device, for example, a chip, a processor, or a processing unit in the first network device, and an action of the second network device in the method may be performed by an apparatus/a module in the second network device, for example, a chip, a processor, or a processing unit in the second network device. This is not specifically limited in embodiments of this application. For example, as described in connection with FIG. 8, the communication method includes the following steps.

S801: The first network device obtains a configuration parameter.

The configuration parameter includes at least one of a time parameter, a location parameter, and ephemeris information.

The time parameter indicates time during which load balancing is performed. For example, the time parameter may indicate a time point at which the load balancing is performed, or may indicate a time period in which the load balancing is performed.

If the time parameter indicates the time point at which the load balancing is performed, the time point may be a start time or an end time. In this way, the first network device may determine, based on the time point and a preconfigured time period, a time period in which the load balancing is performed. The start time indicates a time point at which execution of the load balancing starts, and the end time indicates a time point at which execution of the load balancing ends.

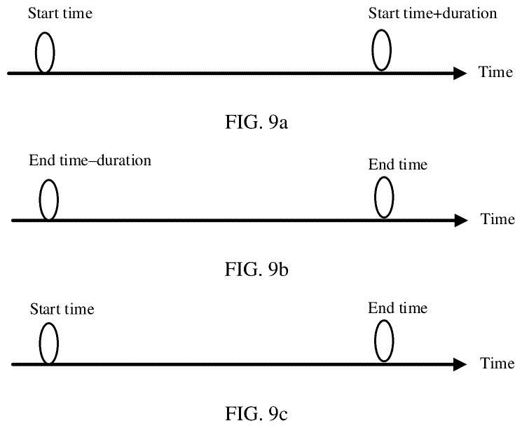

If the time parameter indicates the time period in which the load balancing is performed, the time period may be represented in the following three manners. In one or more embodiments, as described in connection with FIG. 9a, the time parameter includes a start time and a duration. In another possible implementation, as described in connection with FIG. 9c, the time parameter may include a start time and an end time. In another possible implementation, as described in connection with FIG. 9b, the time parameter includes an end time and a duration. The foregoing is merely an example description of the manner of representing the time period. The time period may be represented in another way. This is not limited in embodiments of this application.

In addition, the time point or the time period may be an absolute time point or an absolute time period, or may be a relative time point or a relative time period. This is not limited in embodiments of this application.

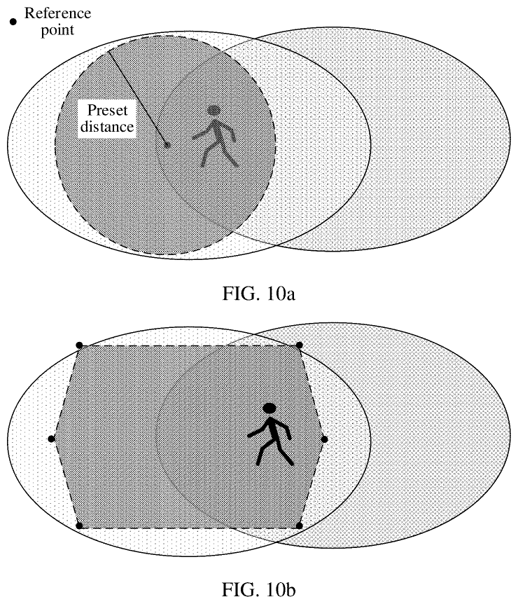

The location parameter indicates an area in which the load balancing is performed. The area may be represented in the following two manners. In one or more embodiments, the location parameter may include longitude and latitude information and a preset distance of at least one reference point, and this implementation is usually applicable to a regular area. For example, as described in connection with FIG. 10a, the area indicated by the location parameter is a circular area (that is, a regular area). In this case, the area in which the load balancing is performed and that is indicated by the location parameter may be determined by using a reference point in the location parameter as an origin and a preset distance in the location parameter as a midpoint.

In another possible implementation, the location parameter may include longitude and latitude information of a plurality of reference points, and this implementation is usually applicable to an irregular area. For example, as described in connection with FIG. 10b, the area indicated by the location parameter is an irregular area. In this case, the area in which the load balancing is performed and that is indicated by the location parameter is determined by connecting a plurality of reference points into a line.

The ephemeris information may include a satellite traveling trajectory, a coverage tilt, or coverage time. The satellite traveling trajectory may be represented by using a satellite orbit and a traveling radius, or may be represented by using location information at each of a plurality of moments. The foregoing is merely an example description of the ephemeris information, and the ephemeris information may further include other information. This is not limited in embodiments of this application.

In one or more embodiments, the configuration parameter may further include a signal strength parameter, where the signal strength parameter indicates a signal strength range for performing the load balancing. In this way, the first network device may combine the at least one of the time parameter, the location parameter, and the ephemeris information with the signal strength parameter, to generate first information. This expands diversity of parameters required for performing the load balancing, so as to better improve a load balancing effect. For example, signal strength may be RSRP. The foregoing is merely an example description of the signal strength. The signal strength may be another network indicator. This is not limited in embodiments of this application.

The foregoing is merely an example description of the configuration parameter, and the configuration parameter may further include another parameter. This is not limited in embodiments of this application.

In some embodiments, the first network device may obtain the configuration parameter in the following two manners. In Manner 1, the first network device obtains the configuration parameter from a third network device side. In Manner 2, the first network device determines the configuration parameter by itself. The following describes Manner 1 and Manner 2 in detail.

In Manner 1, the first network device obtains the configuration parameter from the third network device side. In Manner 1, a third network device may send the configuration parameter to the first network device, and correspondingly, the first network device receives the configuration parameter from the third network device. This reduces complexity of obtaining the configuration parameter, and simplifies a system design.

In an example, the third network device may be a digital twin entity. The digital twin entity is configured to simulate a process of performing the load balancing based on the configuration parameter. In this example, the digital twin entity may further provide the first network device with information such as a predicted quantity of satellites, coverage time of satellites in different areas, a satellite capacity, and total time of satellite traveling. This is not limited in embodiments of this application.

Further, with reference to the foregoing example, before the first network device obtains the configuration parameter from the third network device side, the first network device may send seventh information to the third network device, and correspondingly, the third network device receives the seventh information from the first network device, where the seventh information includes a twin object, a twin parameter, and ephemeris information, so that the third network device can determine the configuration parameter based on the seventh information. The twin object includes at least one physical network object, and the twin parameter includes a configuration parameter corresponding to each of the at least one physical network object.

After the first network device obtains the configuration parameter from the third network device side, if the first network device is to update the configuration parameter, the first network device may re-send seventh information to the third network device, so that the third network device can re-determine a configuration parameter.

It may be understood that, because the ephemeris information is affected by a plurality of factors, it is difficult to simply determine the time parameter and/or the location parameter. Therefore, Manner 1 is more applicable to a case in which the first network device does not have a strong computing capability.

In one or more embodiments, the first network device may be an EMS or an NMS. If the first network device is the EMS, the digital twin entity may be deployed in the first network device. In this case, the digital twin entity may be referred to as a digital twin entity branch, and a simulation environment of the digital twin entity branch should be the same as that of an independently deployed digital twin entity. If a deviation occurs in the simulation environment of the digital twin entity branch, the digital twin entity branch cannot normally simulate the process of performing the load balancing based on the configuration parameter, and the independently deployed digital twin entity should simulate the process of performing the load balancing based on the configuration parameter.

Further, the first network device should pre-construct the digital twin entity branch. For example, a process in which the first network device constructs the digital twin entity branch may be as follows: An NMS sends fourth information (which may also be referred to as a digital twin entity branch creation request) to the first network device, and correspondingly, the first network device receives the fourth information from the NMS, where the fourth information indicates configuration information of the digital twin entity branch. The first network device constructs the digital twin entity branch based on the configuration information of the digital twin entity branch, and sends fifth information to the NMS, where the fifth information indicates whether the digital twin entity branch is successfully created. If the fifth information indicates that the digital twin entity branch fails to be created, the fifth information may further indicate a reason why the digital twin entity branch fails to be created.

However, if the NMS wants a service provided by the digital twin entity branch, the NMS may invoke, through the first network device, the service provided by the digital twin entity branch.

In addition, the first network device may further have a capability of modifying the digital twin entity branch. For example, a process in which the first network device modifies the digital twin entity branch may be as follows: The first network device sends a digital twin entity branch modification request to the third network device, and correspondingly, the third network device may receive the digital twin entity branch modification request from the first network device, where the digital twin entity branch modification request indicates an identifier of the digital twin entity branch and to-be-modified information (for example, added information and information for modification). The third network device may modify the digital twin entity branch based on the digital twin entity branch modification request.

In Manner 2, the first network device determines the configuration parameter by itself. In Manner 2, the first network device may receive the ephemeris information, and determine the configuration parameter based on the ephemeris information. In this case, the configuration parameter usually includes the time parameter and/or the location parameter.

In some examples, the first network device may receive the ephemeris information from a second network device side, or may receive the ephemeris information from another network device (for example, a satellite) side. This is not limited in embodiments of this application.

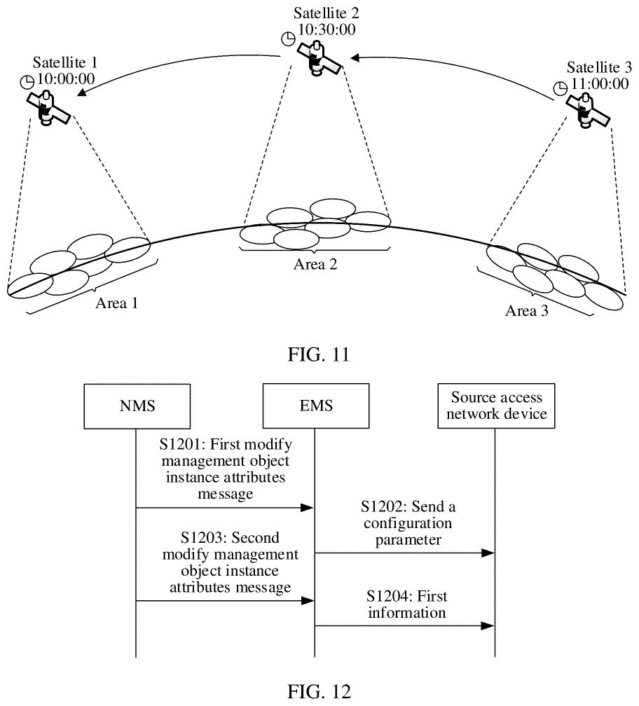

In one or more embodiments, the first network device may determine the configuration parameter in a plurality of manners. For example, the first network device determines the configuration parameter by using a neural network model. For example, the first network device may input the ephemeris information into the neural network model, to obtain the configuration parameter. For another example, the first network device may calculate, by using artificial intelligence (AI) and the ephemeris information, a coverage area of a satellite or a coverage area of a satellite in a target time period, and determine the configuration parameter based on the coverage area of the satellite that is obtained through calculation, for example, as described in connection with FIG. 11, a coverage area 1 of a satellite 1 at 10:00, a coverage area 2 at 10:30, and a coverage area 3 at 11:00, or the coverage area of the satellite in the target time period.

The foregoing is merely an example for description of an implementation in which the first network device obtains the configuration parameter. The first network device may obtain the configuration parameter by using another method. For example, when the first network device is the EMS, the first network device may obtain the configuration information from an NMS side. This is not limited in this application.

In one or more embodiments, when the first network device is the EMS, the second network device may be a source access network device. In this case, the first network device may obtain the configuration parameter from an NMS, where the configuration parameter may be carried in the first modify management object instance message recorded in S101; and send the configuration parameter to the source access network device, so that the EMS, the NMS, and the source access network device can all learn of the configuration parameter. When the first network device is the NMS, the second network device may be an EMS. In this case, the first network device may send the configuration parameter to the EMS, where the configuration parameter may be carried in the first modify management object instance message recorded in S101; and the EMS sends the configuration parameter to a source access network device, so that the EMS, the NMS, and the source access network device can all learn of the configuration parameter.

Further, when the second network device is a source access network device, the source access network device and a fourth network device (that is, a target access network device) may further negotiate to modify the configuration parameter. For an implementation process in which the second network device (that is, the source access network device) and the fourth network device (namely, the target access network device) negotiate to modify the configuration parameter, refer to related descriptions of S109 and S110 for understanding. Details are not described herein again.

S804: The first network device sends the first information to the second network device, and correspondingly, the second network device receives the first information from the first network device.

The first information indicates to perform the load balancing based on the configuration parameter.

In one or more embodiments, the second network device may be an access network device whose load is greater than or equal to a load threshold. In this case, the first network device may indicate, by using the first information, the second network device to perform the load balancing based on the configuration parameter. The load balancing may be an operation of indicating a terminal to be handed over to the fourth network device. The fourth network device may be an access network device whose load is less than the load threshold.

In one or more embodiments, the communication method recorded in embodiments of this application may be applied to not only a TN network, but also an NTN network. However, different types of networks adapt to different configuration parameters. For example, a configuration parameter to which the TN network adapts may include at least one of the following: a time parameter, a location parameter, or a signal strength parameter. For another example, a configuration parameter to which the NTN network adapts may include at least one of the following: a time parameter, a location parameter, a signal strength parameter, or ephemeris information. In view of this, the first network device may further determine, based on a network type, a configuration parameter suitable for the network type. For example, the first network device may perform indication for load balancing of different types of networks, so that the second network device can better perform the load balancing, so as to better improve a load balancing effect. In view of this, in this case, the second information may further indicate to perform the load balancing based on a target parameter, and the target parameter is determined from the configuration parameter based on the network type.

In addition, the target parameter may be determined based on an actual network situation (for example, distribution of terminals in a communication network). For example, if the terminals are distributed in a centralized manner, the location parameter may be preferentially considered for the target parameter; or if the terminals are distributed in a dispersed manner, the time parameter or the ephemeris information may be preferentially considered for the target parameter.

In one or more embodiments, when the first network device is the EMS, the second network device may be a source access network device. In this case, the first network device may obtain the first information from an NMS, where the first information may be carried in the second modify management object instance message recorded in S103; and send the first information to the source access network device, so that the EMS, the NMS, and the source access network device can all learn of the first information. When the first network device is the NMS, the second network device may be an EMS. In this case, the first network device may send the first information to the EMS, where the first information may be carried in the second modify management object instance message recorded in S103, and the EMS sends the first information to a source access network device, so that the EMS, the NMS, and the source access network device all can learn of the first information.

In one or more embodiments, before S804, the first network device may further indicate the second network device to enable a load balancing function, so that the second network device can directly perform the load balancing based on the configuration parameter after subsequently receiving the first information.

This application provides the communication method. The first network device may obtain the configuration parameter, and send the first information, to indicate to perform the load balancing based on the configuration parameter. The configuration parameter recorded in this application may include at least one of the time parameter, the location parameter, or the ephemeris information. Compared with the signal strength parameter, at least one of the time parameter, the location parameter, or the ephemeris information can be better used to control a quantity of terminals to be handed over, and therefore can be better adapted to an NTN scenario, and load balancing between NTN cells can be effectively controlled.

In one or more embodiments, before S804, to ensure as much as possible that the load balancing can be normally performed, the first network device and the third network device may jointly verify the obtained configuration parameter, to determine feasibility of the configuration parameter indicated by the second information, so that the first network device can subsequently control, based on the feasibility of the configuration parameter indicated by the second information, whether to perform the load balancing. In view of this, as described in connection with FIG. 8, the communication method provided in one or more embodiments of this application further includes the following steps S802 and S803.

S802: The first network device sends the second information to the third network device, and correspondingly, the third network device receives the second information from the first network device.

The second information indicates the configuration parameter obtained by the first network device.

In one or more embodiments, the second information may further indicate a twin object and/or a twin parameter. The foregoing is merely an example description of the second information, and the second information may further indicate other information. This is not limited in embodiments of this application. For understanding of the twin object and the twin parameter, refer to the foregoing descriptions in corresponding parts. Details are not described herein again.

S803: The third network device sends third information to the first network device, and correspondingly, the first network device receives the third information from the third network device.

The third information indicates the feasibility of the configuration parameter indicated by the second information.

For example, the feasibility of the configuration parameter indicated by the second information may be represented by a percentage. For example, the feasibility of the configuration parameter indicated by the second information is 80%. The foregoing is merely an example description of a manner of representing the feasibility of the configuration parameter indicated by the second information. The feasibility of the configuration parameter indicated by the second information may be represented in another manner. This is not limited in embodiments of this application.

In one or more embodiments, before S803, the third network device may perform simulation verification on the configuration parameter indicated by the second information, to obtain a simulation verification result, and generate the third information based on the simulation verification result. The simulation verification result may indicate the feasibility of the configuration parameter indicated by the second information.

Further, after the first network device learns of the feasibility of the configuration parameter indicated by the second information, S804 may be replaced with S804A.

S804A: When the feasibility of the configuration parameter indicated by the second information meets a preset requirement, the first network device sends the first information to the second network device, and correspondingly, the second network device receives the first information from the first network device.

For example, when the feasibility of the configuration parameter indicated by the second information may be represented by a percentage, the preset requirement may be that the feasibility is greater than or equal to a feasibility threshold (for example, 90%). The feasibility threshold may be set by the third network device based on an actual situation or experience. This is not limited in embodiments of this application.

Further, when the feasibility of the configuration parameter indicated by the second information does not meet the preset requirement, to help ensure that the load balancing can be performed, the first network device may modify the configuration parameter indicated by the second information, to obtain a modified configuration parameter, and send the third information to the second network device. Correspondingly, the second network device receives the third information from the first network device. The third information indicates to perform load balancing based on the modified configuration parameter.

In one or more embodiments, before the first network device sends the third information, the first network device and the third network device may further jointly verify feasibility of the modified configuration parameter, and send the third information to the second network device when the feasibility of the modified configuration parameter meets the preset requirement.

In addition, when the feasibility of the configuration parameter indicated by the second information does not meet the preset requirement, the fourth information may further indicate the modified configuration parameter. In this way, the first network device may directly send the third information to the second network device, and may not modify the configuration parameter indicated by the second information, so as to reduce a processing burden of the first network device.

It should be noted that, in the foregoing recorded communication method, the first network device and the third network device jointly verify the feasibility of the configuration parameter indicated by the second information. However, the first network device and the third network device may further jointly verify a load balancing effect that can be achieved by the configuration parameter indicated by the second information. For example, if the third network device verifies that a load difference between the second network device and the fourth network device can be less than or equal to 5 bps if the load balancing is performed based on the configuration parameter indicated by the second information, the first network device may further send the first information to the second network device.

In one or more embodiments, the network type includes a TN type and an NTN type, so that the communication method recorded in this application can be applied to a TN scenario and/or an NTN scenario, thereby enriching application scenarios of the solutions provided in this application.

In one or more embodiments, as described in connection with FIG. 12, the following describes the communication method recorded in embodiments of this application by using an example in which the first network device is an EMS and the second network device is a source access network device.

S1201: An NMS sends a first modify management object instance attributes (modify MOI attributes) message to the EMS, and the EMS receives the first modify management object instance attributes message from the NMS.

The first modify management object instance attributes (modify MOI attributes) message may include a configuration parameter. The configuration parameter may include at least one of the following: a time parameter, a location parameter, ephemeris information, or signal strength information.

S1202: The EMS sends the configuration parameter to the source access network device, and the source access network device receives the configuration parameter from the EMS.

In one or more embodiments, before S1202, the EMS selects the source access network device based on an actual network state.

S1203: The NMS sends a second modify management object instance attributes message to the EMS, and the EMS receives the second modify management object instance attributes message from the NMS.

The second modify management object instance attributes message includes first information.

S1204: The EMS sends the first information to the source access network device, and the source access network device receives the first information from the EMS.

In one or more embodiments, the EMS determines, based on the actual network state, to enable a load balancing switch, and sends, to the source access network device, a message indicating to enable the load balancing switch. The source access network device receives, from the EMS, the message indicating to enable the load balancing switch.

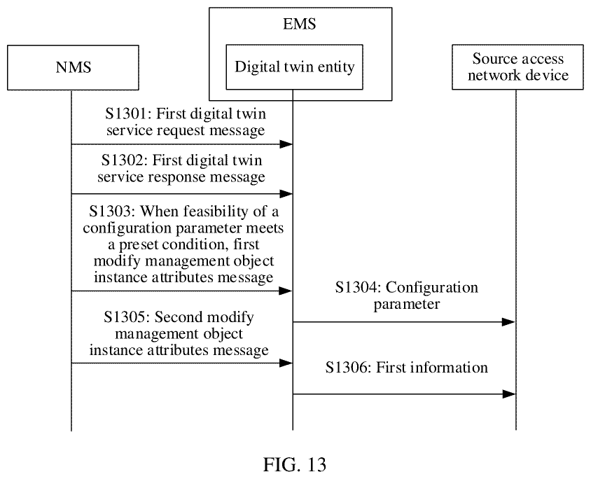

In one or more embodiments, as described in connection with FIG. 13, the following describes the communication method recorded in embodiments of this application by using an example in which the first network device is an EMS, the second network device is a source access network device, the third network device is a digital twin entity, and the third network device is deployed in the first network device. A main difference from the communication method described in connection with FIG. 12 lies in that, in the communication method described in connection with FIG. 13, the third network device may be used to jointly verify a configuration parameter.

S1301: An NMS sends a first digital twin service request message to the digital twin entity, and correspondingly, the digital twin entity receives the first digital twin service request message from the NMS.

The first digital twin service request message may include at least one of the following: a configuration parameter, a twin object, or a twin parameter. For understanding of the configuration parameter, the twin object, or the twin parameter, refer to the foregoing descriptions in corresponding parts. Details are not described herein again.

S1302: The digital twin entity sends a first digital twin service response message to the NMS, and the NMS receives the digital twin service response message from the first digital twin entity.

The first digital twin service response message may include feasibility of the configuration parameter and/or a modified configuration parameter.

It should be noted that, when the feasibility of the configuration parameter does not meet a preset condition, the digital twin service response message carries the modified configuration parameter (for example, a modified time parameter, a modified location parameter, and a modified signal strength parameter).

In addition, if the EMS intends to invoke the digital twin entity again, S1301 and S1302 may be performed again between the NMS and the digital twin entity.

S1303: When the feasibility of the configuration parameter meets the preset condition, the NMS sends a first modify management object instance attributes message to the EMS, and the EMS receives the first modify management object instance attributes message from the NMS.

S1304: The EMS sends the configuration parameter to the source access network device, and the source access network device receives the configuration parameter from the EMS.

S1305: The NMS sends a second modify management object instance attributes message to the EMS, and the EMS receives the second modify management object instance attributes message from the NMS.

S1306: The EMS sends first information to the source access network device, and the source access network device receives the first information from the EMS.

It may be understood that for understanding of S1303 to S1306, refer to S1201 to S1204. Details are not described herein again.

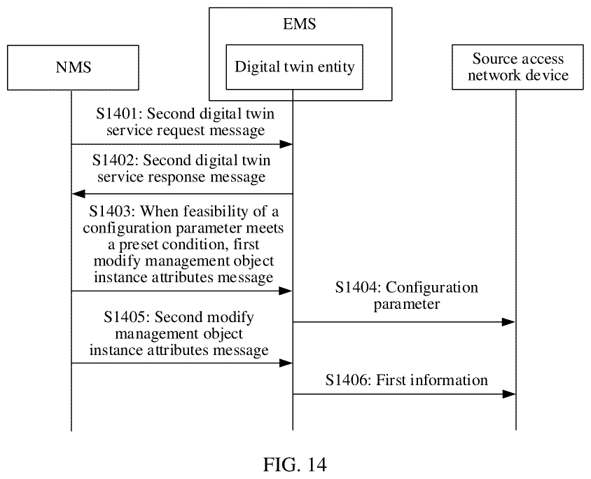

In one or more embodiments, as described in connection with FIG. 14, the following describes the communication method recorded in embodiments of this application by using an example in which the first network device is an EMS, the second network device is a source access network device, and the third network device is a digital twin entity. A main difference from the communication method described in connection with FIG. 12 lies in that, in the communication method described in connection with FIG. 14, the third network device may determine a configuration parameter.

S1401: An NMS sends a second digital twin service request message to the digital twin entity, and correspondingly, the digital twin entity receives the second digital twin service request message from the NMS.

The second digital twin service request message may include at least one of the following: ephemeris information, a twin object, or a twin parameter. For understanding of the ephemeris information, the twin object, or the twin parameter, refer to the foregoing descriptions in corresponding parts. Details are not described herein again.

S1402: The digital twin entity sends a second digital twin service response message to the NMS, and the NMS receives the second digital twin service response message from the digital twin entity.

The second digital twin service response message may include a configuration parameter, a quantity of satellites, coverage time of satellites in different areas, a satellite capacity, or total time of satellite traveling.

In addition, if the EMS intends to invoke the digital twin entity again, S1401 and S1402 may be performed again between the NMS and the digital twin entity.

S1403: When feasibility of the configuration parameter meets a preset condition, the NMS sends a first modify management object instance attributes message to the EMS, and the EMS receives the first modify management object instance attributes message from the NMS.

S1404: The EMS sends the configuration parameter to the source access network device, and the source access network device receives the configuration parameter from the EMS.

S1405: The NMS sends a second modify management object instance attributes message to the EMS, and the EMS receives the second modify management object instance attributes message from the NMS.

S1406: The EMS sends first information to the source access network device, and the source access network device receives the first information from the EMS.

It may be understood that for understanding of S1403 to S1406, refer to S1201 to S1204. Details are not described herein again.

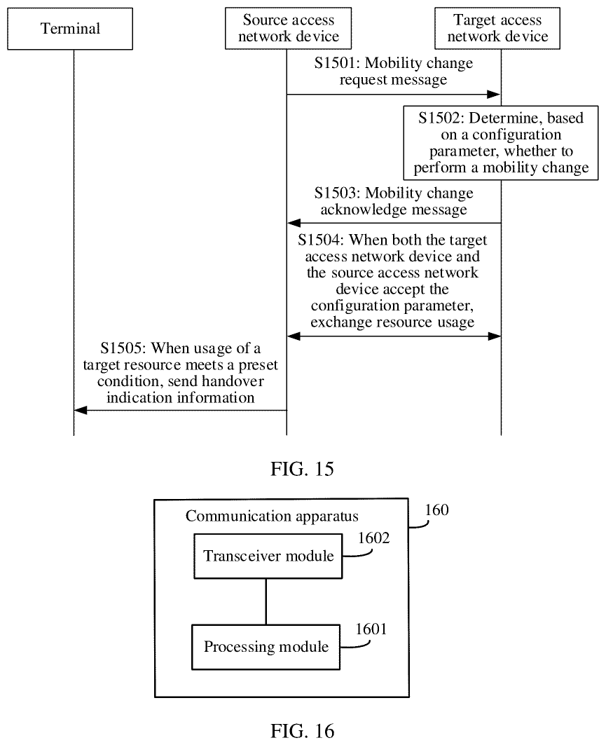

In one or more embodiments, as described in connection with FIG. 15, the following describes the communication method recorded in embodiments of this application by using an example in which the second network device is a source access network device. A main difference from the communication method described in connection with FIG. 12 lies in that the communication method described in connection with FIG. 15 is mainly for interaction between access network devices.

S1501: The source access network device sends a mobility change request message to a target access network device, and correspondingly, the target access network device receives the mobility change request message from the source access network device.

The mobility change request message may include a configuration parameter.

S1502: The target access network device determines, based on the configuration parameter, whether to perform a mobility change.

S1503: The target access network device sends a mobility change acknowledge message to the source access network device, and correspondingly, the source access network device receives the mobility change acknowledge message from the target access network device.

The mobility change acknowledge message indicates that the configuration parameter is accepted, or the mobility change acknowledge message indicates that the configuration parameter is not accepted, and carries a configuration parameter modified by the target access network device.

S1504: When both the target access network device and the source access network device accept the configuration parameter, the source access network device exchanges resource usage with the target access network device.

S1505: When usage of a target resource meets a preset condition, the source access network device sends handover indication information to a terminal based on the configuration parameter, and correspondingly, the terminal receives the handover indication information from the source access network device.

The handover indication information indicates the terminal to be handed over to the target access network device.

It should be noted that the foregoing is merely an example description of the communication method. For understanding of a communication method in another case (for example, the first network device is an NMS, and the source access network device is an EMS), refer to descriptions in corresponding parts. Details are not described herein again.

The foregoing mainly describes the solutions provided in embodiments of this application from a perspective of interaction between network elements. Correspondingly, one or more embodiments of this application further provides a communication apparatus, and the communication apparatus is configured to implement the foregoing methods. The communication apparatus may be the network device in the foregoing method embodiments, an apparatus including the network device, or a component that can be used in the network device. In one or more embodiments, the communication apparatus may be the terminal device in the foregoing method embodiments, an apparatus including the terminal device, or a component that can be used in the terminal device. It may be understood that, to implement the foregoing functions, the communication apparatus includes corresponding hardware structures and/or software modules for performing the functions. A person skilled in the art should easily be aware that units and algorithm steps in the examples described with reference to embodiments disclosed in this specification can be implemented by hardware or a combination of hardware and computer software in this application. Whether a function is performed by hardware or hardware driven by computer software depends on specific applications and design constraint conditions of the technical solutions. A person skilled in the art may use different methods to implement the described functions for each specific application, but it should not be considered that the implementation goes beyond the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be understood that module division in embodiments of this application is an example, and is merely logical function division. In actual implementation, there may be another division manner.

For example, the communication apparatus is the terminal device in the foregoing method embodiments. FIG. 16 is a diagram of a structure of a communication apparatus 160. The communication apparatus 160 includes a processing module 1601 and a transceiver module 1602. The transceiver module 1602 may also be referred to as a transceiver unit, and is configured to implement a transceiver function. For example, the transceiver module 1602 may be a transceiver circuit, a transceiver machine, a transceiver, or a communication interface.

When the communication apparatus 160 described in connection with FIG. 16 is the first network device in the foregoing embodiment, in one or more embodiments,
a processing module 1601 is configured to indicate the transceiver module 1602 to obtain a configuration parameter and send first information, where the configuration parameter includes at least one of a time parameter, a location parameter, and ephemeris information, and the first information indicates to perform load balancing based on the configuration parameter.

In some embodiments, the time parameter indicates time for performing the load balancing, and the location parameter indicates an area in which the load balancing is performed.

In some embodiments, the processing module 1601 is further configured to indicate the transceiver module 1602 to receive a configuration parameter from a third network device.

In some embodiments, the processing module 1601 is further configured to indicate the transceiver module 1602 to send second information to the third network device, where the second information indicates a configuration parameter obtained by the first network device; and the processing module 1601 is further configured to indicate the transceiver module 1602 to receive third information from the third network device, where the third information indicates feasibility of the configuration parameter indicated by the second information.

In some embodiments, when the feasibility of the configuration parameter indicated by the second information meets a preset requirement, the processing module 1601 is further configured to indicate the transceiver module 1602 to send the first information to the second network device.

In some embodiments, the processing module 1601 is further configured to indicate the transceiver module 1602 to receive the ephemeris information; and the processing module 1601 is further configured to determine the configuration parameter based on the ephemeris information.

In some embodiments, the configuration parameter further includes a signal strength parameter, and the signal strength parameter indicates a signal strength range for performing the load balancing.

In some embodiments, the first information further indicates to perform the load balancing based on a target parameter, and the target parameter is determined from the configuration parameter based on a network type.

In some embodiments, the network type includes a terrestrial network TN type and a non-terrestrial network NTN type.

All related content of the steps in the foregoing method embodiments may be cited in function descriptions of the corresponding functional modules. Details are not described herein again.

In embodiments of this application, the first network device is presented in a form of obtaining each functional module through division in an integrated manner. The “module” herein may be an ASIC, a circuit, a processor that executes one or more software or firmware programs, a memory, an integrated logic circuit, and/or another device capable of providing the foregoing functions. In a simple embodiment, a person skilled in the art may figure out that the first network device may be in a form of the communication apparatus 700 described in connection with FIG. 7.

For example, the processor 701 in the communication apparatus 700 described in connection with FIG. 7 may invoke the computer-executable instructions stored in the memory 703, so that the communication apparatus 700 performs the communication method in the foregoing method embodiments.

For example, functions/implementation processes of the transceiver module 1602 and the processing module 1601 in FIG. 16 may be implemented by the processor 701 in the communication apparatus 700 described in connection with FIG. 7 by invoking the computer-executable instructions stored in the memory 703. In one or more embodiments, a function/an implementation process of the processing module 1601 in FIG. 16 may be implemented by the processor 701 in the communication apparatus 700 described in connection with FIG. 7 by invoking the computer-executable instructions stored in the memory 703, and a function/an implementation process of the transceiver module 1602 in FIG. 16 may be implemented by the communication interface 704 in the communication apparatus 700 described in connection with FIG. 7.

The communication apparatus 160 provided in embodiments of this application can perform the foregoing communication methods of the first network device. Therefore, for technical effects that can be achieved by the communication apparatus 160, refer to the foregoing method embodiments. Details are not described herein again.

When the communication apparatus 160 described in connection with FIG. 16 is the second network device in the foregoing embodiment,
in one or more embodiments,
a processing module 1601 is configured to indicate the transceiver module 1602 to receive first information, where the first information indicates to perform load balancing based on a configuration parameter, and the configuration parameter includes at least one of a time parameter, a location parameter, and ephemeris information.

In some embodiments, the time parameter indicates time for performing the load balancing, and the location parameter indicates an area in which the load balancing is performed.

In some embodiments, the configuration parameter further includes a signal strength parameter, and the signal strength parameter indicates a signal strength range for performing the load balancing.

In some embodiments, the first information further indicates to perform the load balancing based on a target parameter, and the target parameter is determined from the configuration parameter based on a network type.

In some embodiments, the network type includes a terrestrial network TN type and a non-terrestrial network NTN type.

All related content of the steps in the foregoing method embodiments may be cited in function descriptions of the corresponding functional modules. Details are not described herein again.

In embodiments of this application, the second network device is presented in a form of obtaining each functional module through division in an integrated manner. The “module” herein may be an ASIC, a circuit, a processor that executes one or more software or firmware programs, a memory, an integrated logic circuit, and/or another device capable of providing the foregoing functions. In a simple embodiment, a person skilled in the art may figure out that the second network device may be in a form of the communication apparatus 700 described in connection with FIG. 7.

For example, the processor 701 in the communication apparatus 700 described in connection with FIG. 7 may invoke the computer-executable instructions stored in the memory 703, so that the communication apparatus 700 performs the communication method in the foregoing method embodiments.

For example, functions/implementation processes of the transceiver module 1602 and the processing module 1601 in FIG. 16 may be implemented by the processor 701 in the communication apparatus 700 described in connection with FIG. 7 by invoking the computer-executable instructions stored in the memory 703. In one or more embodiments, a function/an implementation process of the processing module 1601 in FIG. 16 may be implemented by the processor 701 in the communication apparatus 700 described in connection with FIG. 7 by invoking the computer-executable instructions stored in the memory 703, and a function/an implementation process of the transceiver module 1602 in FIG. 16 may be implemented by the communication interface 704 in the communication apparatus 700 described in connection with FIG. 7.

The communication apparatus 160 provided in embodiments can perform the foregoing communication methods of the second network device. Therefore, for technical effects that can be achieved by the communication apparatus 160, refer to the foregoing method embodiments. Details are not described herein again.

It should be understood that one or more of the modules or units may be implemented by software, hardware, or a combination thereof. When any one of the modules or units is implemented by software, the software exists in a form of computer program instructions, and is stored in a memory, and a processor may be configured to execute the program instructions and implement the foregoing method procedures. The processor may be built into a SoC (system-on-a-chip) or an ASIC, or may be an independent semiconductor chip. In addition to a core for executing software instructions to perform operations or processing, the processor may further include a hardware accelerator, for example, a field programmable gate array (FPGA), a PLD (programmable logic device), or a logic circuit that implements a dedicated logic operation.

When the foregoing modules or units are implemented by using hardware, the hardware may be any one or any combination of a CPU, a microprocessor, a digital signal processing (DSP) chip, a microcontroller unit (MCU), an artificial intelligence processor, an ASIC, a SoC, an FPGA, a PLD, a dedicated digital circuit, a hardware accelerator, or a non-integrated discrete device, and the hardware may run software or does not depend on software to perform the foregoing method procedures.

One or more embodiments, further provides a communication apparatus (for example, the communication apparatus may be a chip or a chip system). The communication apparatus includes a processor, configured to implement the method in any one of the foregoing method embodiments. In a possible design, the communication apparatus further includes a memory. The memory is configured to store program instructions and data. The processor may invoke program code stored in the memory, to indicate the communication apparatus to perform the method in any one of the foregoing method embodiments. The memory may not be in the communication apparatus. When the communication apparatus is a chip system, the communication device may include a chip, or may include a chip and another discrete device. This is not specifically limited in embodiments of this application.

One or more embodiments, further provides a computer-readable storage medium. The computer-readable storage medium stores a computer program or instructions. When the computer program or the instructions are run on a communication apparatus, the communication apparatus is caused to perform the method in any one of the foregoing method embodiments or one or more embodiments of the foregoing method embodiments.

One or more embodiments of this application further provides a communication method. The communication method includes the method in any one of the foregoing method embodiments or one or more embodiments of the foregoing method embodiments.

One or more embodiments of this application further provides a communication system. The communication system includes the terminal device in the foregoing method embodiments and the network device in the foregoing method embodiments.

All or some of the foregoing embodiments may be implemented by software, hardware, firmware, or any combination thereof. When a software program is used to implement embodiments, embodiments may be implemented completely or partially in a form of a computer program product. The computer program product includes one or more computer instructions. When the computer program instructions are loaded and executed on a computer, all or some of the procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk drive, or a magnetic tape), an optical medium (for example, a DVD), a semiconductor medium (for example, a solid-state drive (SSD)), or the like.

Although this application is described with reference to embodiments, in a process of implementing this application that claims protection, a person skilled in the art may understand and implement another variation of the disclosed embodiments by viewing the accompanying drawings, disclosed content, and the accompanying claims. In the claims, “comprising” does not exclude another component or another step, and “a” or “one” does not exclude a plurality of cases. A single processor or another unit may implement several functions enumerated in the claims. Some measures are recorded in dependent claims that are different from each other, but this does not mean that these measures cannot be combined to produce a better effect.

Although this application is described with reference to specific features and embodiments thereof, that various modifications and combinations may be made to this application without departing from the spirit and scope of this application. Correspondingly, the specification and accompanying drawings are merely example descriptions of this application defined by the appended claims, and are considered as any of or all modifications, variations, combinations or equivalents that cover the scope of this application. A a person skilled in the art can make various modifications and variations to this application without departing from the spirit and scope of this application. This application is intended to cover these modifications and variations of this application provided that they fall within the scope of protection defined by the following claims and their equivalent technologies.

1. A communication method, performed by a first network device, wherein the method comprises:
obtaining a configuration parameter, wherein the configuration parameter comprises at least one of a time parameter, a location parameter, or ephemeris information; and
sending first information, wherein the first information indicates to perform load balancing based on the configuration parameter.

2. The method according to claim 1, wherein the time parameter indicates time for performing the load balancing, and the location parameter indicates an area in which the load balancing is performed.

3. The method according to claim 1, wherein the obtaining the configuration parameter comprises:
receiving the configuration parameter from a third network device.

4. The method according to claim 1, wherein the method further comprises:
sending second information to a third network device, wherein the second information indicates the configuration parameter obtained by the first network device; and
receiving third information from the third network device, wherein the third information indicates feasibility of the configuration parameter indicated by the second information.

5. The method according to claim 4, wherein the sending the first information comprises:
in response to the feasibility of the configuration parameter indicated by the second information meets a preset requirement, sending the first information to a second network device.

6. The method according to claim 1, wherein the configuration parameter comprises at least one of the time parameter or the location parameter, and the obtaining the configuration parameter comprises:
receiving the ephemeris information; and
determining the configuration parameter based on the ephemeris information.

7. The method according to claim 1, wherein the configuration parameter further comprises a signal strength parameter, and the signal strength parameter indicates a signal strength range for performing the load balancing.

8. The method according to claim 1, wherein the first information further indicates to perform the load balancing based on a target parameter, and the target parameter is determined from the configuration parameter based on a network type.

9. The method according to claim 8, wherein the network type comprises a terrestrial network (TN) type and a non-terrestrial network (NTN) type.

10. A communication apparatus, comprising at least one processor, and the at least one processor is configured to cause, by running a computer program or instructions or by using a logic circuit, the communication apparatus to perform the steps of:
obtaining a configuration parameter, wherein the configuration parameter comprises at least one of a time parameter, a location parameter, or ephemeris information; and
sending first information, wherein the first information indicates to perform load balancing based on the configuration parameter.

11. The communication apparatus according to claim 10, wherein the step of the obtaining comprises:
receiving the configuration parameter from a third network device.

12. The communication apparatus according to claim 10, wherein the at least one processor is further configured to:
send second information to a third network device, wherein the second information indicates the configuration parameter obtained by the first network device; and
receive third information from the third network device, wherein the third information indicates feasibility of the configuration parameter indicated by the second information.

13. The communication apparatus according to claim 12, wherein the step of the sending comprises:
in response to the feasibility of the configuration parameter indicated by the second information meets a preset requirement, sending the first information to a second network device.

14. The communication apparatus according to claim 10, wherein the configuration parameter comprises at least one of the time parameter or the location parameter, and the step of the obtaining comprises:
receiving the ephemeris information; and
determining the configuration parameter based on the ephemeris information.

15. A communication system, comprising:
a first network device, configured to obtain a configuration parameter, wherein the configuration parameter comprises at least one of a time parameter, a location parameter, and ephemeris information; and send first information to a second network device, wherein the first information indicates to perform load balancing based on the configuration parameter; and
the second network device, configured to receive the first information.

16. The communication system according to claim 15, wherein the first network device is further configured to:
receive the configuration parameter from a third network device.

17. The communication system according to claim 15, wherein the first network device is further configured to:
send second information to a third network device, wherein the second information indicates the configuration parameter obtained by the first network device; and
receive third information from the third network device, wherein the third information indicates feasibility of the configuration parameter indicated by the second information.

18. The communication system according to claim 17, wherein the first network device is further configured to:
in response to the feasibility of the configuration parameter indicated by the second information meets a preset requirement, send the first information to the second network device.

19. The communication system according to claim 15, wherein the time parameter indicates time for performing the load balancing, and the location parameter indicates an area in which the load balancing is performed.

20. The communication system according to claim 15, wherein the configuration parameter further comprises a signal strength parameter, and the signal strength parameter indicates a signal strength range for performing the load balancing.
